(19) United States
(12) Patent Application Publication
(10) Pub. No.: US 2019/0141548 A1
(43) Pub. Date: May 9, 2019

(54) MECHANISM FOR DETERMINING IF A SERVER POD MALFUNCTIONS AND ELECTING A NEW SERVER POD

(71) Applicant: QUALCOMM Incorporated, San Diego, CA (US)

(72) Inventor: Stephen BURT, Cambridge (GB)

(21) Appl. No.: 15/803,619

(22) Filed: Nov. 3, 2017

(51) Int. Cl. H04W 24/04; G06F 11/14; H04W 88/12

(52) U.S. Cl. CPC H04W 24/04; H04W 84/12; H04W 88/12; G06F 11/1423

(57) ABSTRACT

In an aspect of the disclosure, a method, a computer-readable medium, and an apparatus are provided. The apparatus may determine if at least one UDP beacon is received from a server device during a client listen state. The apparatus may enter a client connect state when it is determined that the at least one UDP beacon is received from the server device. The apparatus may attempt to establish a TLS connection with the server device during the client connect state.

### BACKGROUND

### Field

The present disclosure relates generally to communication systems, and more particularly, to a mechanism for determining if a server pod malfunctions and electing a new server pod.

### Background

A wireless personal area network (WPAN) is a short-range wireless network that interconnects devices centered around a specific distance from a user. WPANs that are based on short-range communication technology (e.g., a Bluetooth® (BT) protocol, a BT Low-Energy® (BLE) protocol, a Zigbee® protocol, etc.) provide wireless connectivity to peripheral devices within a specific distance (e.g., 5 meters, 10 meter, 20 meters, 100 meters, etc.) from a central device. In contrast to a WPAN, a wireless local area network (WLAN) provides connectivity to devices that are located within a larger geographical area, such as the area covered by a building or a campus, for example. WLANs are typically based on a IEEE 802.11 protocol (e.g., Wi-Fi protocol), and operate within a 100-meter or greater than 100-meter range. In some instances, WLANs may operate in conjunction with WPANs to provide users with an enhanced overall functionality.

In order to communicate within both a WPAN and a WLAN, a wireless device may have multiple radio interfaces that each support a different radio access technology (RAT) defined by a specific communication protocol (e.g., Wi-Fi, BT, etc.). Accordingly, a wireless device may concurrently operate multiple radio interfaces corresponding to multiple RATs (e.g., Wi-Fi, BT, etc.) in order to operate within both a WPAN and a WLAN.

A wireless pod is one type of wireless device that may concurrently operate within both a WPAN and a WLAN. Wireless pods may communicate with certain peripheral devices (e.g., wireless earbuds, wireless headphones, etc.) within a WPAN using the BT protocol, and with certain other peripheral devices (e.g., smartphones, other wireless pods, etc.) within a WLAN using the Wi-Fi protocol. Wireless pods may also use the Wi-Fi protocol to connect to the Internet via a router. Examples of wireless pods include smart speakers such as Amazon Echo™, Google Home™, Apple HomePod™, etc.

When multiple wireless pods are located within a WLAN (e.g., home, office, warehouse, etc.), enabling communication between the wireless pods may be beneficial. In certain configurations, wireless pods may communicate with one another via a designated server pod that relays messages between wireless pods. However, if the server pod malfunctions (e.g., is no longer able to relay messages), there may not be a mechanism for the other wireless pods to determine that a malfunction has occurred, and messages between wireless pods may not be received.

Thus, there is a need for a mechanism to determine if a server pod malfunctions and to elect a new server pod.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. The summary's sole purpose is to present some concepts of one or more aspects in a simplified form as a prelude to the more detailed description that is presented later.

A wireless pod is one type of wireless device that may concurrently operate within both a WPAN and a WLAN. For example, wireless pods may communicate with certain peripheral devices (e.g., wireless earbuds, wireless headphones, etc.) within a WPAN using the BT protocol, and with certain other peripheral devices (e.g., smartphones, other wireless pods, etc.) within a WLAN using the Wi-Fi protocol. Wireless pods may also use the Wi-Fi protocol to connect to the Internet via a router. Examples of wireless pods include smart speakers such as Amazon Echo™, Google Home™, Apple HomePod™, etc.

Wireless pods may connect to a voice-controlled intelligent personal assistant service that responds to a “wake word”, and may perform operations such as voice interaction, music playback, making to-do lists, setting alarms, streaming podcasts, playing audio books, and providing weather, traffic and other real-time information, just to name a few. A wireless pod may act as a automation hub and control other smart devices (e.g., smart lighting, smart thermostat, smart television, etc.) within a home, office, and/or warehouse.

Using a wireless connection between wireless earbuds and a smart phone, one or more wireless pods may relay audio data packets from the smart phone to the wireless earbuds, and vice versa, so that the user may move throughout the WPAN/WLAN without carrying the smart phone.

Thus, enabling communication between multiple wireless pods in a WLAN (e.g., home, office, etc.) may be beneficial in order to transfer a connection with the wireless earbuds from a first wireless pod located in a first location to a second wireless pod in a second location. Enabling communication between multiple wireless pods using a broadcast protocol, such as a user datagram protocol (UDP), may enable all of the wireless pods to directly communicate with any of the other wireless pods in the WLAN. However, broadcast protocols may not be reliable since broadcast protocols emphasize reduced latency rather than reliability (e.g., error correction of data packets transmitted using UDP may not be supported).

Enabling communication between multiple wireless pods using a connection-oriented protocol, such as transmission control protocol (TCP), may provide a mechanism by which data packets may be error corrected, and hence, provide additional reliability as compared to UDP. In addition, security may be provided over TCP using a transport layer security (TLS) connection. When TCP is used to enable communication between multiple client pods, a server node may be used to relay messages between wireless pods rather than by direct communication. However, if the server pod malfunctions (e.g., is no longer able to relay messages), there may not be a mechanism for the other wireless pods to determine that the malfunction has occurred and/or to elect a new server pod. Hence, messages between wireless pods may not be received, and voice packets may be dropped.

Thus, there is a need for a mechanism to enable reliable and secure communications between multiple wireless devices, to determine if a server pod malfunctions, and to elect a new server pod.

The present disclosure provides a mechanism by which wireless pods may communicate reliably and securely using a combination of UDP and TCP, may be able to determine when a server pod malfunctions, and which may be used to elect a new server pod when a server pod malfunction occurs.

For example, a server pod may be configured to transmit a UDP beacon at predetermined intervals to indicate that the server pod is functional to the other wireless pods. When it is determined that the server pod is no longer functional, the other wireless pods may perform a server election procedure until a server pod is elected, at which point the remaining wireless pods may establish a TLS connection with the new server pod.

In an aspect of the disclosure, a method, a computer-readable medium, and an apparatus are provided. The apparatus may determine if at least one UDP beacon is received from a server device during a client listen state. The apparatus may enter a client connect state when it is determined that the at least one UDP beacon is received from the server device. The apparatus may attempt to establish a TLS connection with the server device during the client connect state.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN and WLAN in accordance with certain aspects of the disclosure.

FIG. 2 is block diagram of a wireless device in accordance with certain aspects of the disclosure.

FIGS. 3A and 3B illustrate a wireless network that supports wireless communications between a server pod and a plurality of wireless devices in accordance with certain aspects of the disclosure.

FIGS. 3C-3I illustrate a data flow that may be used by one or more client pods to determine if a server pod malfunctions and to elect a new server pod in accordance with certain aspects of the disclosure.

FIG. 4 is a flowchart of a method of wireless communication.

FIG. 5 is a conceptual data flow diagram illustrating the data flow between different means/components in an exemplary apparatus.

FIG. 6 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, as will be apparent to those skilled in the art such concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

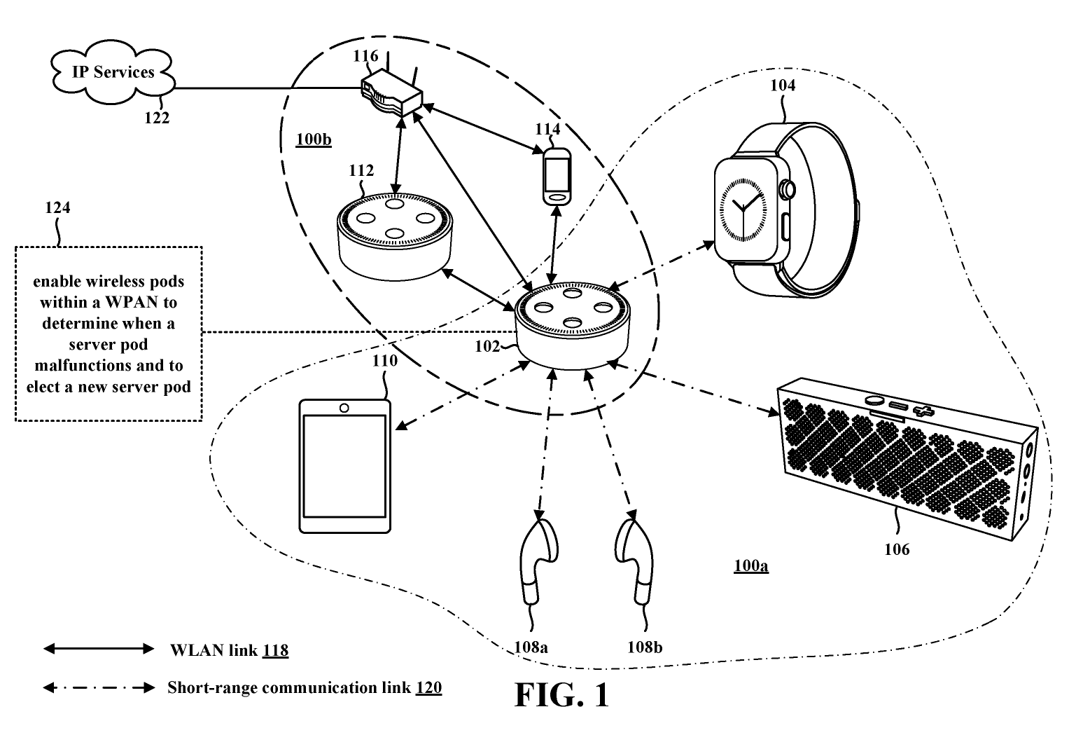

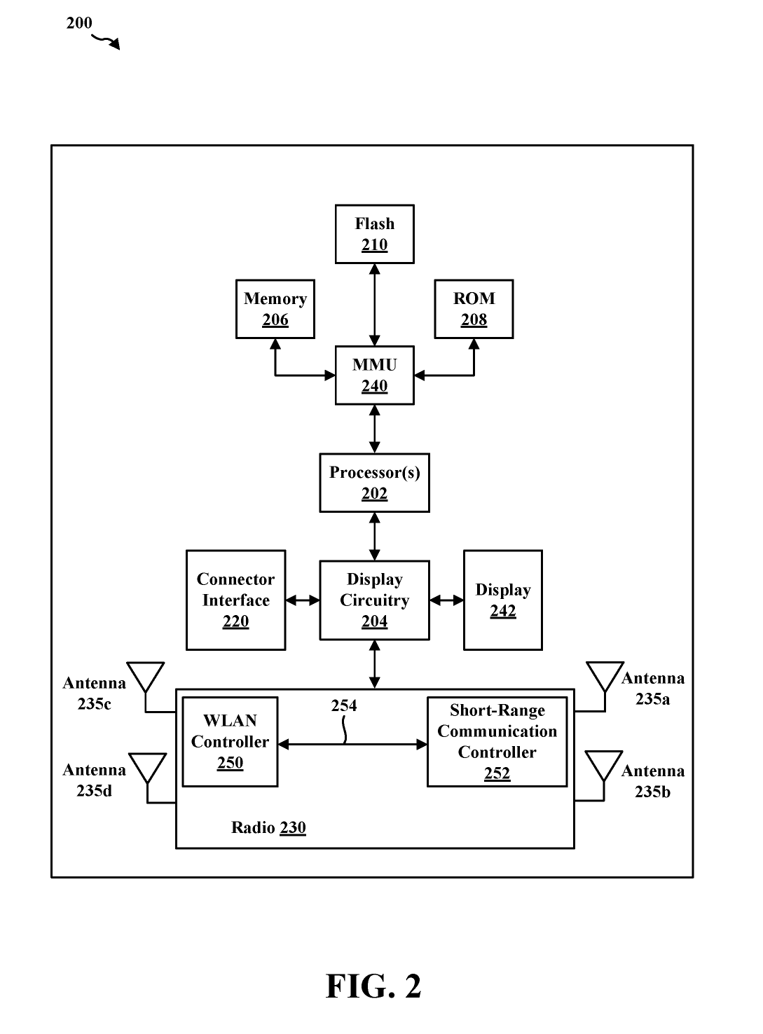

FIG. 1 illustrates an example WPAN 100a and a WLAN 100b in accordance with certain aspects of the disclosure. A first device 102 may be part of both the WPAN 100a and the WLAN 100b, and thus be configured to operate multiple radio interfaces corresponding to multiple RATs (e.g., Wi-Fi, BT, etc.) concurrently. For example, a BT radio interface at the first device 102 may be used for communication within the WPAN 100a, and a Wi-Fi interface at the first device 102 may be used for communication within the WLAN 100b. Shared antennas for different RATs may be used by the first device 102, e.g., as discussed below with reference to FIG. 2. The shared antennas may be used for, e.g., short-range communications via a short-range communication link 120 and Wi-Fi communications via a WLAN link 118. In certain aspects, short-range communications and Wi-Fi communications may be performed using the same frequency band (e.g., 2.4-2.4835 GHz frequency range, 5 GHz frequency range, etc.). In certain other aspects, short-range communications and Wi-Fi communications may be performed using different frequency bands.

Examples of the first device 102 may include a wireless pod, a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similarly functioning device.

Within the WPAN 100a, the first device 102 (e.g., central device) may communicate with one or more second devices 104, 106, 108a, 108b, 110 (e.g., peripheral devices) using a short-range communications protocol (e.g., BT protocol, Zigbee® protocol, etc.). Examples of the one or more second devices 104, 106, 108a, 108b, 110 may include a wireless pod, a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device such as a smart watch or wireless earbuds, a vehicle, an electric meter, a gas pump, a toaster, or any other similarly functioning device. Although the first device 102 is illustrated in communication with five second devices 104, 106, 108a, 108b, 110 in the WPAN 100a, the first device 102 may communicate with more or fewer than five devices within the WPAN 100a without departing from the scope of the present disclosure.

Within the WLAN 100b, the first device 102 may communicate with at least one third device 112, 114, 116 using a Wi-Fi communications protocol (e.g., IEEE 802.11 protocol, etc.). The third device 116 may be configured to connect to Internet Protocol (IP) Services 122. The IP Services 122 may include the Internet, an intranet, an IP Multimedia Subsystem (IMS), a PS Streaming Service, and/or other IP services. The third device 116 may communicate information between the first device 102 and IP Services 122. Examples of the one or more third devices 112, 114, 116 include a smart phone, a wireless pod, a Wi-Fi router and/or a Wi-Fi AP. Wi-Fi communications may be performed using a 5 GHz unlicensed spectrum. When communicating in an unlicensed frequency spectrum, the first device 102 and/or one or more third devices 116 may perform a clear channel assessment (CCA) prior to communicating with one another in order to determine whether the channel is available.

In certain configurations, the first device 102 may be a server pod in communication with one or more client pod(s) 112. When the first device 102 is elected as the server pod (e.g., by the client pods(s) 112), the first device 102 may accept client connections from other client pods. Other applications may use the client connections to communication with the client pods. For example, the server pod may forward messages received from one client pod to another client pod. A communication manager at the first device 102 may establish a reliable, secure communication channel (e.g., via the WLAN link 118) between wireless pods. The communication channel may be used to communicate data packets between client pods in the WLAN 100b. In certain configurations, the communication channel may be used to broadcast data packets to client pods in the WLAN 100b. The communication channel may be maintained by the server pod. The server pod may relay messages from one wireless pod to another wireless pod in the WLAN 100b that is a target of the message.

Referring again to FIG. 1, in certain aspects, the first device 102 may be configured to enable client pods to determine when a server pod malfunctions and to elect a new server pod (at 124), e.g., as described below in connection with any of FIGS. 2-6.

FIG. 2 is block diagram of a wireless device 200 in accordance with certain aspects of the disclosure.

As shown in FIG. 2, the wireless device 200 may include a processing element, such as processor(s) 202, which may execute program instructions for the wireless device 200. The wireless device 200 may also include display circuitry 204 which may perform graphics processing and provide display signals to the display 242. The processor(s) 202 may also be coupled to memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry (e.g., for Wi-Fi, BT, BLE, cellular, etc.). The wireless device 200 may include a plurality of antennas 235a, 235b, 235c, 235d, for performing wireless communication with, e.g., wireless devices in a WPAN and/or WLAN.

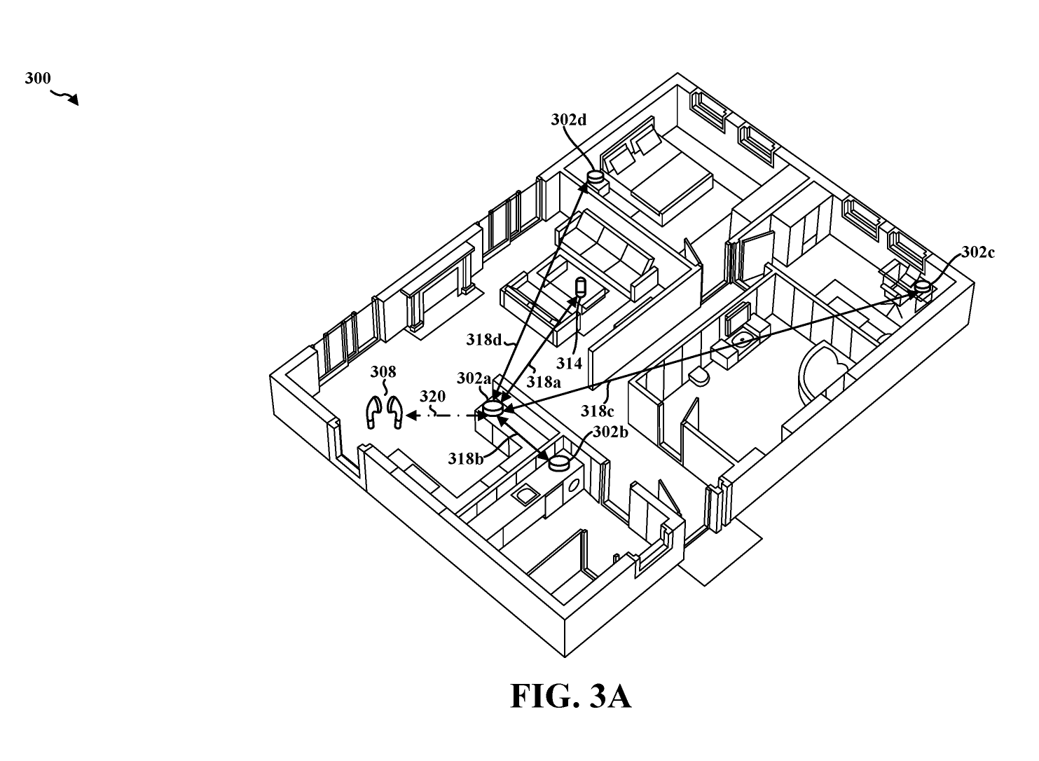

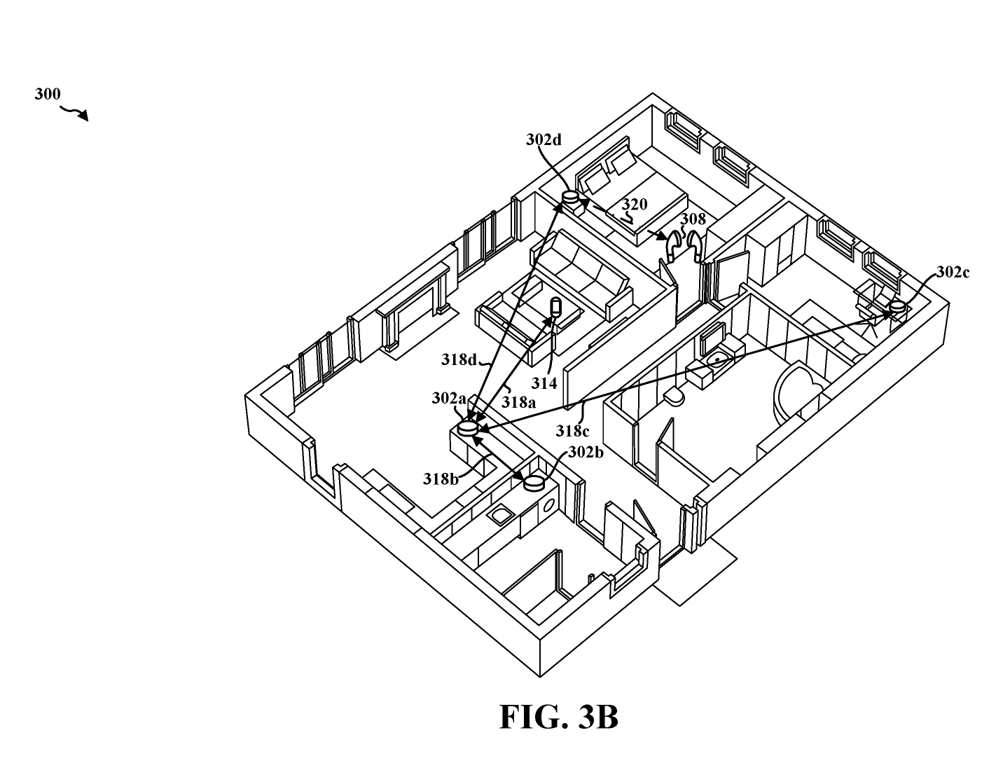

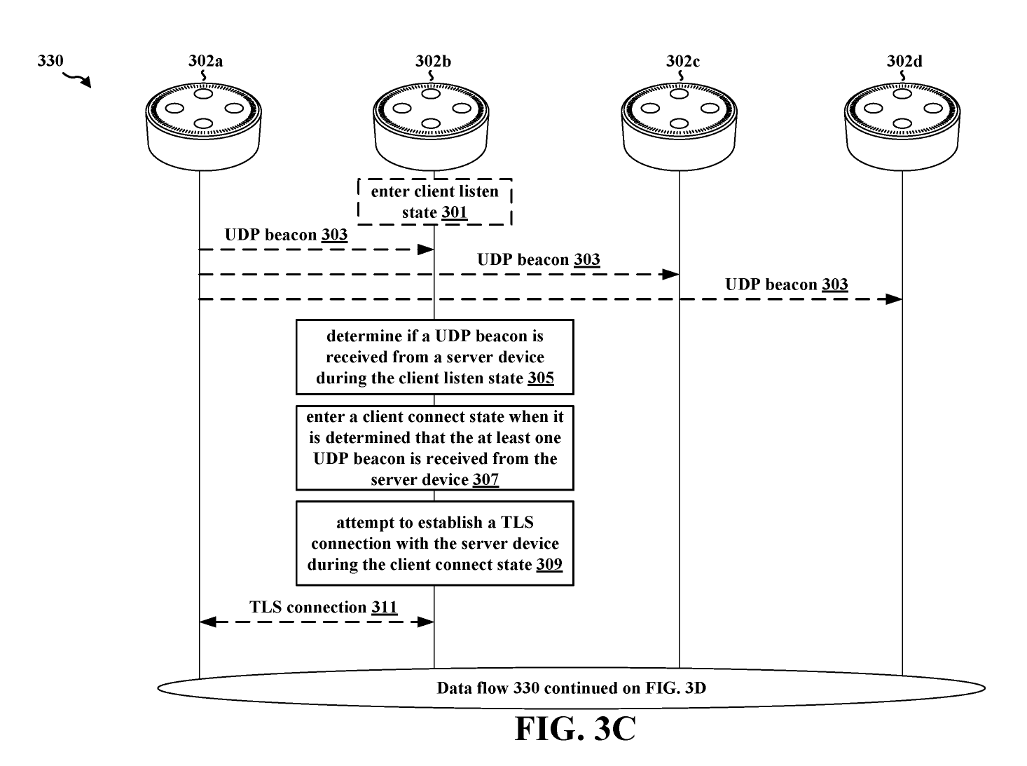

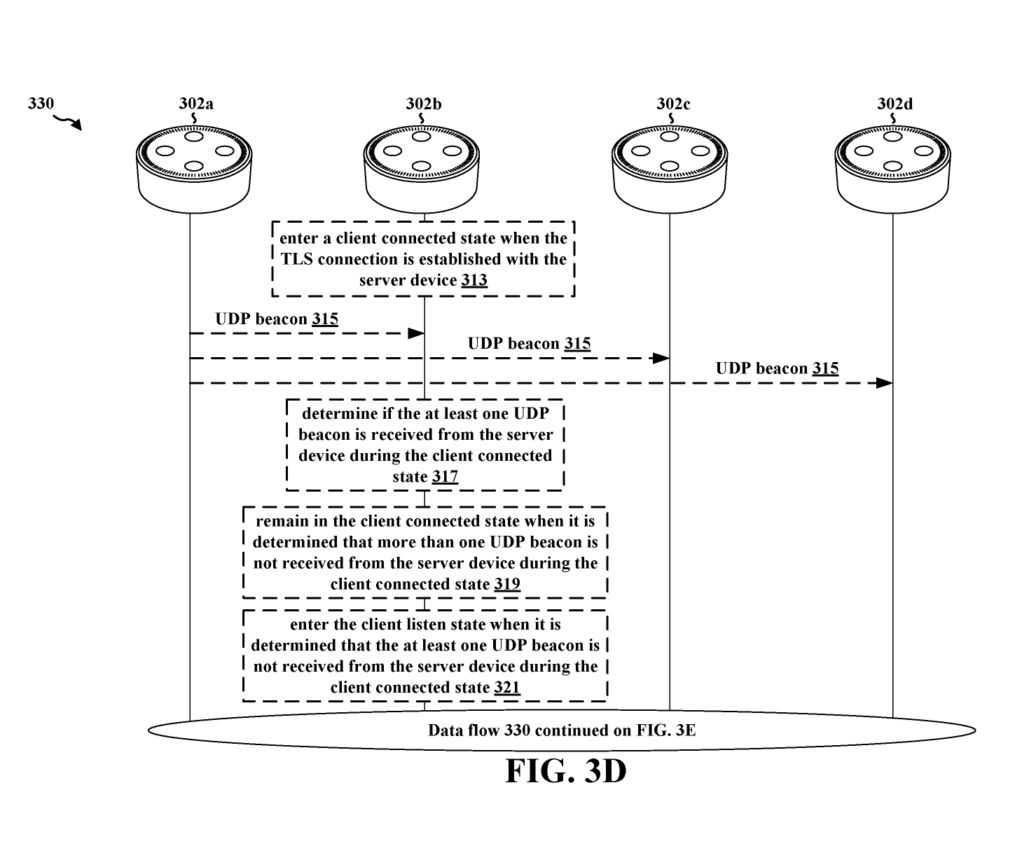

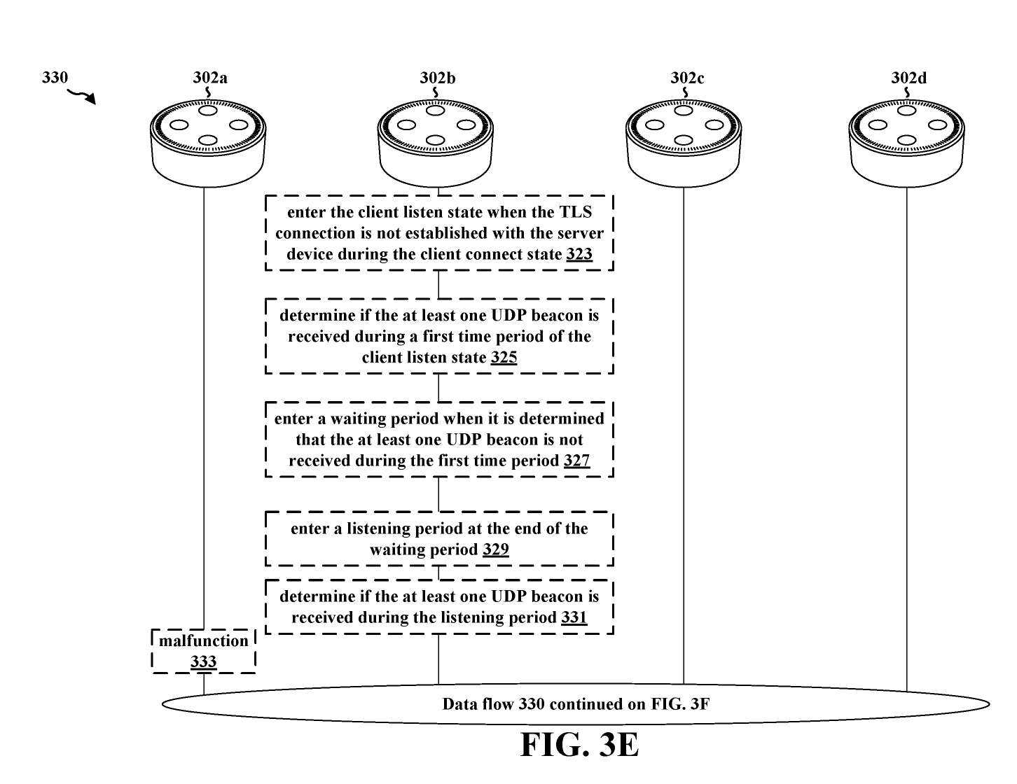

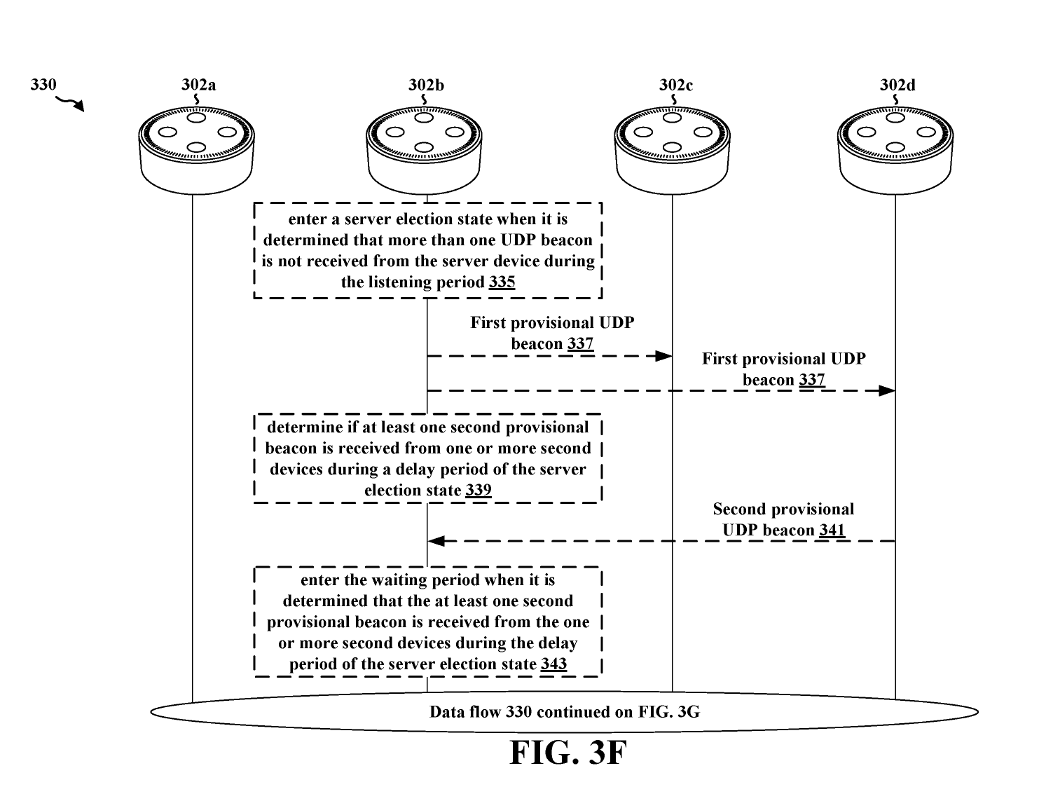

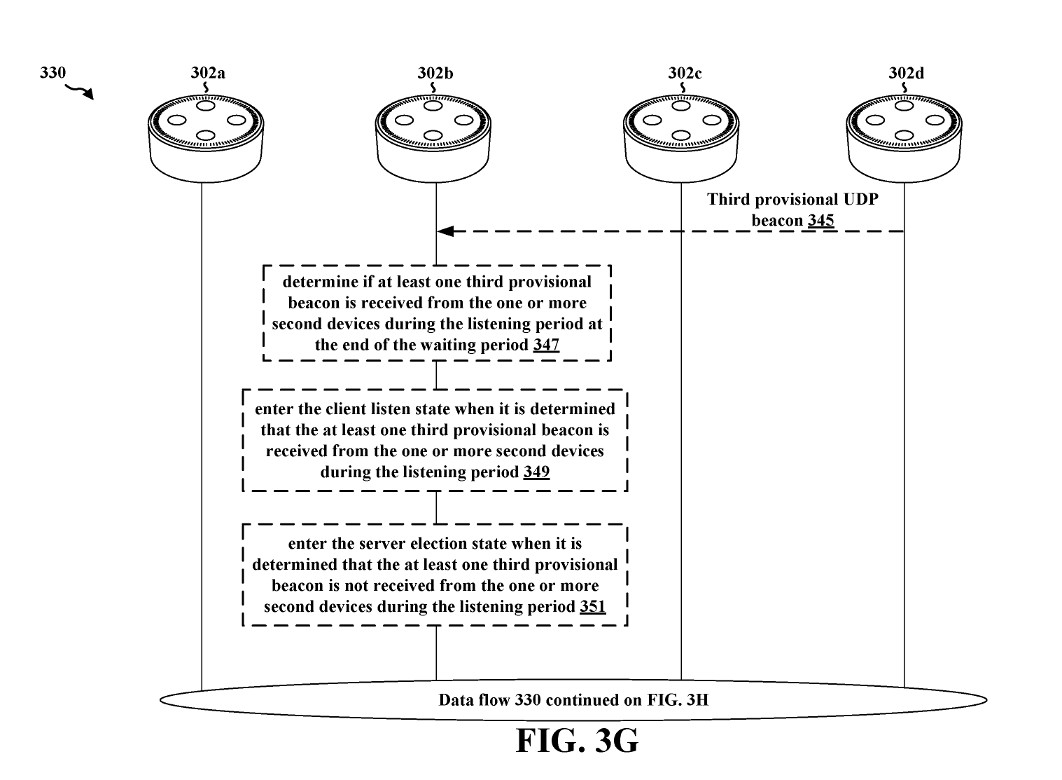

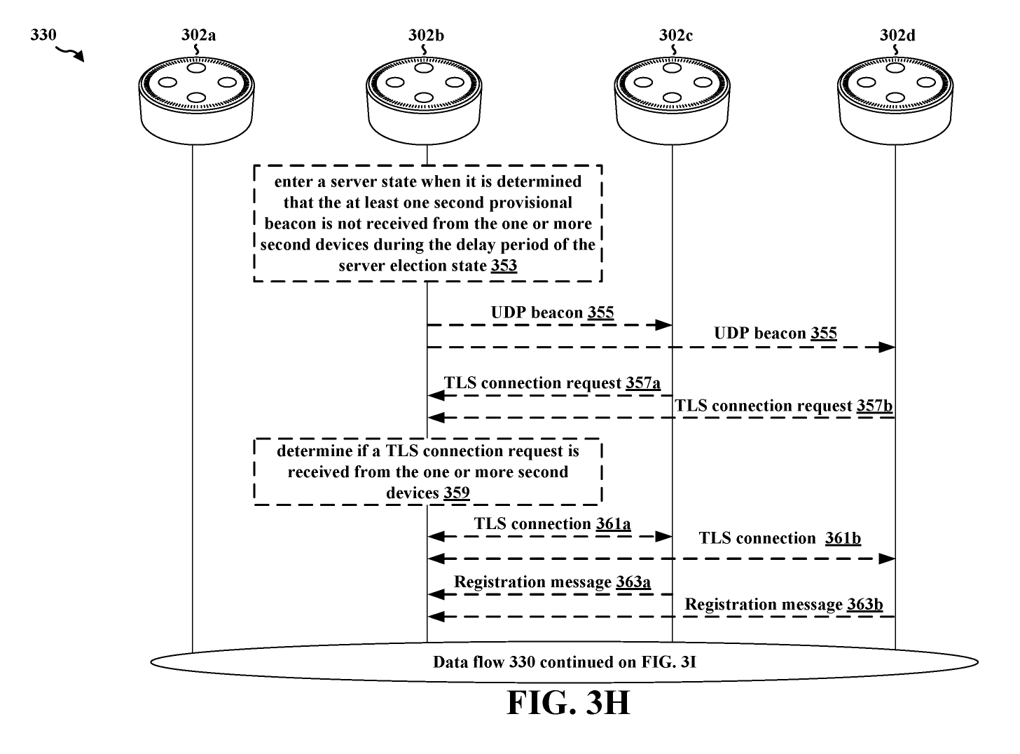

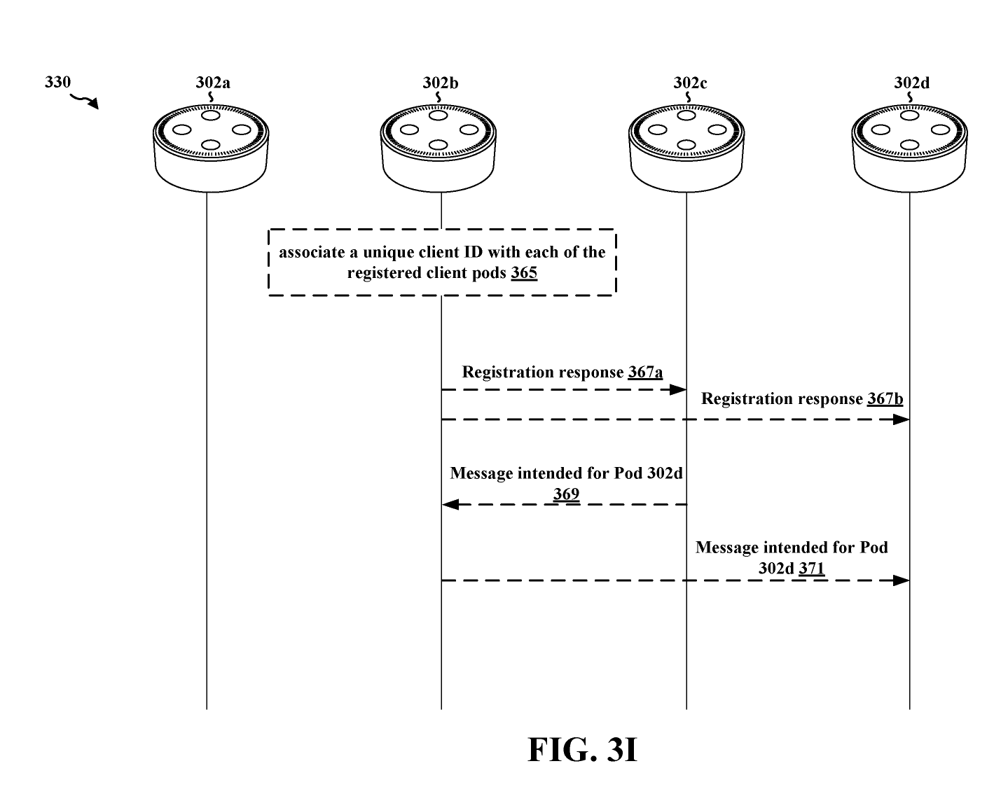

In certain aspects, the wireless device 200 may include hardware and software components (a processing element) configured to enable client pods to determine when a server pod malfunctions and to elect a new server pod, e.g., using the techniques described below in connection with any FIGS. 3A-6. The wireless device 200 may also comprise BT and/or BLE firmware or other hardware/software for controlling BT and/or BLE operations.

The wireless device 200 may be configured to implement part or all of the techniques described below in connection with any of FIGS. 3A-6, e.g., by executing program instructions stored on a memory medium (e.g., a non-transitory computer-readable memory medium) and/or through hardware or firmware operation. In other embodiments, the techniques described below in connection with any of FIGS. 3A-6 may be at least partially implemented by a programmable hardware element, such as an field programmable gate array (FPGA), and/or an application specific integrated circuit (ASIC).

In certain aspects, radio 230 may include separate controllers configured to control communications for various respective RAT protocols. For example, as shown in FIG. 2, radio 230 may include a WLAN controller 250 configured to control WLAN communications, and a short-range communication controller 252 configured to control short-range communications. In certain aspects, the wireless device 200 may store and execute a WLAN software driver for controlling WLAN operations performed by the WLAN controller 250, and/or a short-range communication software driver for controlling short-range communication operations performed by the short-range communication controller 252.

In certain implementations, a coexistence interface 254 (e.g., a wired interface) may be used for sending information between the WLAN controller 250 and the short-range communication controller 252.

In some aspects, one or more of the WLAN controller 250 and/or the short-range communication controller 252 may be implemented as hardware, software, firmware or some combination thereof.

In certain configurations, the WLAN controller 250 may be configured to communicate with a second device in a WLAN using a WLAN link using all of the antennas 235a, 235b, 235c, 235d. In certain other configurations, the short-range communication controller 252 may be configured to communicate with at least one second device in a WPAN using one or more of the antennas 235a, 235b, 235c, 235d. One or more of the processor(s) 202, the WLAN controller 250, and/or the short-range communication controller 252 may be configured to enable client pods to determine when a server pod malfunctions and to elect a new server pod.

One or more wireless pods may relay audio data packets from the smart phone to the wireless earbuds, and vice versa, using a wireless connection between the wireless earbuds and the smart phone so that the user may move throughout the WPAN/WLAN without carrying the smart phone.

Thus, enabling communication between multiple wireless pods in a WLAN (e.g., home, office, etc.) may be beneficial in order to transfer a connection with the wireless earbuds from a first client pod located in a first location to a second client pod in a second location. In certain configurations, client pods may communicate with one another via a designated server pod that relays messages between client pods. For example, the client pod that is most proximate to the smart phone may relay voice packets from the smart phone to the wireless earbuds via the server pod, and vice versa, as described below in connection with FIGS. 3A and 3B.

FIGS. 3A and 3B illustrate a wireless network 300 that supports wireless communications between a server pod 302a (e.g., a wireless pod), a first client pod 302b, a second client pod 302c, a third client pod 302d, a first wireless device 308, and a second wireless device 314 in accordance with certain aspects of the disclosure. For example, the wireless network 300 may include both a WPAN and a WLAN located within a home.

The server pod 302a may correspond to, e.g., the first device 102, the third device 112, wireless device 200, the apparatus 502/502′, the second wireless pod 550, the third wireless pod 555, the server pod 560. In the example illustrated in FIGS. 3A and 3B, the server pod 302a is located in the kitchen of the home.

The first client pod 302b may correspond to, e.g., the first device 102, the third device 112, wireless device 200, the apparatus 502/502′, the second wireless pod 550, the third wireless pod 555, the server pod 560. In the example illustrated in FIGS. 3A and 3B, the first client pod 302b is located in a laundry room of the home. The server pod 302a may maintain a first connection 318b, such as a first TLS connection, with the first client pod 302b, and communicate with first client pod 302b using Wi-Fi over the first connection 318b.

The second client pod 302c may correspond to, e.g., the first device 102, the third device 112, wireless device 200, the apparatus 502/502′, the second wireless pod 550, the third wireless pod 555, the server pod 560. In the example illustrated in FIGS. 3A and 3B, the second client pod 302c is located in an office of the home. The server pod 302a may maintain a second connection 318c, such as a second TLS connection, with the second client pod 302c, and communicate with second client pod 302c using Wi-Fi over the second connection 318c.

The third client pod 302d may correspond to, e.g., the first device 102, the third device 112, wireless device 200, the apparatus 502/502′, the second wireless pod 550, the third wireless pod 555, the server pod 560. In the example illustrated in FIGS. 3A and 3B, the third client pod 302d is located in a bedroom of the home. The server pod 302a may maintain a third connection 318d, such as a third TLS connection, with the third client pod 302d, and communicate with third client pod 302d using Wi-Fi over the third connection 318d.

The first wireless device 308 may correspond to, e.g., second device 108a, 108b. In the example illustrated in FIG. 3A, the first wireless device is located in the kitchen. In the example illustrated in FIG. 3B, the first wireless device is located in the bedroom.

The second wireless device 314 may correspond to, e.g., the third device 114. In the example illustrated in FIGS. 3A and 3B, the first wireless device is located in the living room.

In the example illustrated in FIGS. 3A and 3B, the communication area (e.g., the BT communication area) of the second wireless device 314 is located within the living room, and does not extend into the kitchen, the laundry room, the office, and/or the bedroom. Hence, the first wireless device 308 is located outside of the communication area of the second wireless device 314 in FIGS. 3A and 3B, and communications between the first wireless device 308 and the second wireless device 314 are relayed between one or more wireless nodes.

In certain configurations, the first wireless device 308 may be wireless earbuds and the second wireless device 314 may be a smart phone. The first wireless device 308 may perform operations such as “hands-free” voice calls or audio streaming via the second wireless device 314. In other words, the first wireless device 308 may replace the second wireless device's 314 speakers and microphone while in use.

When the first wireless device 308 is within the communication area of the second wireless device 314 (e.g., when a signal strength between the two wireless devices meets a threshold criteria), hands-free voice calls and/or audio streaming may be performed using a BT link (not shown) between the first wireless device 308 and the second wireless device 314.

However, when the first wireless device 308 moves outside of the short-range communication area of the second wireless device 314 (e.g., when the signal strength between the two wireless devices does not meet the threshold criteria), one or more of the server pod 302a, the first client pod 302b, the second client pod 302c, and/or the third client pod 302d may be used to relay data packets between the first wireless device 308 and the second wireless device 314 using a Wi-Fi connection with the first wireless device 308 and/or the second wireless device 314.

In one aspect, the first wireless device 308 and/or the second wireless device 314 may determine when the signal strength does not meet the threshold criteria, and may send (e.g., broadcasts) a signal to the server pod 302a indicating that the wireless pods should act as a relay(s) between the first wireless device 308 and the second wireless device 314. The server pod 302a may determine a signal strength (e.g., BT signal strength) associated with the first wireless device 308, and may send (e.g., broadcast) a signal instructing each of the first client pod 302b, the second client pod 302c, and the third client pod 302d to determine and report back a respective signal strength (e.g., BT signal strength) associated with the first wireless device 308.

When the server pod 302a has the highest signal strength associated with the first wireless device 308, the server pod 302a may relay data packets to and from the second wireless device 314 without an intervening wireless pod, as in the scenario illustrated in FIG. 3A. In certain aspects, data packet communication between the server pod 302a and the first wireless device 308 may occur over the BT communication link 320. In certain other aspects, data packet communication between the server pod 302a and the second wireless device 314 may occur over the Wi-Fi communication link 318a.

Otherwise, when the server pod 302a does not have the highest signal strength associated with the first wireless device 308, the server pod 302a may send a signal instructing the client pod that reported the highest signal strength to begin relaying data packets between the first wireless device 308 and the server pod 302a, and vice versa.

In the scenario illustrated in FIG. 3B, the third client pod 302d reports the highest signal strength, and hence, the server pod 302a sends a signal instructing the third client pod 302d to relay data packets to and/or from the first wireless device 308 to the server pod 302a. The server pod 302a may relay the data packets to and/or from the third client pod 302d to the second wireless device 314, and vice versa.

Thus, enabling communication between multiple client pods in a WLAN (e.g., home, office, etc.) may be beneficial in order to transfer a connection with the wireless earbuds from a first wireless pod located in a first location to a second wireless pod in a second location. Enabling communication between multiple wireless pods using a broadcast protocol, such as a UDP, may enable all of the wireless pods to directly communicate with any of the other client pods in the WLAN. However, broadcast protocols may not be reliable since broadcast protocols emphasize reduced latency rather than reliability (e.g., error correction of data packets transmitted using UDP may not be supported).

Enabling communication between multiple wireless pods using a connection-oriented protocol, such as TCP, may provide a mechanism by which data packets may be error corrected to provide additional reliability as compared to UDP. In addition, security may be provided over TCP using a TLS connection. When TCP is used to enable communication between multiple client pods, a server node may be used to relay messages between client pods rather than by direct communication between the client pods. However, if the server pod 302a malfunctions (e.g., is no longer able to relay messages), there may not be a mechanism for the other wireless pods to determine that the malfunction has occurred and/or to elect a new server pod. Hence, messages between wireless pods may not be received, and voice packets may be dropped.

For example, if the server pod malfunctions 302a (e.g., is no longer able to relay messages), there may not be a mechanism for the client pods 302b, 302c, 302d to determine that a server malfunction occurs and to elect a new server pod. Hence, data packets between client pods 302b, 302c, 302d may not be received, and voice and/or audio packets may not be received by the first wireless device 308.

Thus, there is a need to enable the client pods 302b, 302c, 302d to determine when the server pod 302a malfunctions and to elect a new server pod.

The present disclosure provides a mechanism by which the client pods 302b, 302c, 302d may be able to determine when the server pod 302a malfunctions and to elect a new server pod, using the techniques described below in connection with FIGS. 3C-3I.

FIGS. 3C-3I illustrate a data flow 330 that may be used by client pods 302b, 302c, 302d to determine if a server pod 302a malfunctions and to elect a new server pod in accordance with certain aspects of the disclosure. For simplicity, the mechanism is described in connection with the first client pod 302b. However, the mechanism may be performed by each of the client pods 302b, 302c, 302d. In FIGS. 3C-3I, optional operations are indicated with dashed lines.

Referring to FIG. 3C, the first client pod 302b may enter a client listen state (at 301). For example, the first client pod 302b may enter the client listen state when the first client pod 302b is initially powered-on, or when a UDP beacon is not received from server pod 302a when the first client pod 302b is in a client connected state (e.g., see operation 321 in FIG. 3D).

In the example illustrated in FIG. 3C, the server pod 302a is functional, and hence, transmits a UDP beacon 303 (e.g., a server UDP beacon) at predetermined UDP beacon intervals to identify the server pod 302a to a client pod that is joining the network, and/or to indicate to client pods 302b, 302c, 302d pods in network that the server pod 302a is functional. In certain configurations, the UDP beacon may include the IP Address (which may be encrypted) of the server pod 302a, and indicate the port on which a TLS connection may be established.

In certain configurations, the first client pod 302b may determine (at 305) if a UDP beacon is received from the server pod 302a during the client listen state. For example, the first client pod 302b may enter the client listen state (at 301) for a duration that is at least as long as a transmission interval of the UDP beacon (e.g., 1 ms, 10 ms, 50 ms, 100 ms, etc.). In certain configurations, the first client pod 302b may enter the client listen state for a duration that is longer than the transmission interval of the UDP beacon (e.g., ten times longer than the transmission interval). If a UDP beacon is not received during the client listen state, the first client pod 302b may be the first wireless pod to join the network or the server pod 302a may not be functional.

In the particular example illustrated in FIG. 3C, the first client pod 302b receives the UDP beacon from the server pod 302a during the client listen state, and hence, enters a client connect state (at 307) when it is determined (at 305) that the at least one UDP beacon is received from the server pod 302a.

In certain configurations, the first client pod 302b may attempt to establish a TLS connection (at 309) with the server pod 302a during the client connect state using a TLS protocol. The first client pod 302b may attempt to establish the TLS connection using the port and IP Address indicated in the UDP beacon. A TLS connection 311 may provide a cryptographically secure data channel that uses a shared secret key that may be used to encrypt data.

The TLS connection may be established using a TLS protocol that includes a handshake sequence used to determine one or more shared secret key(s) used for encrypted communication between the devices. For example, the handshake sequence may include the use of public key cryptography (also known as asymmetric key cryptography), which allows the server pod 302a and a client pod to negotiate a shared secret key without having to establish any prior knowledge of each other, and to do so over an unencrypted channel. As part of the TLS handshake, the TLS protocol may also enable the respective identities of the server pod 302a and the client pod to be authenticated.

With encryption and authentication in place, the TLS protocol may also provide a message (e.g., data packet) framing mechanism and assigns each message with a message authentication code (MAC). The MAC may be a cryptographic hash function (e.g., a checksum), the shared secret key(s) to which are negotiated by both the server pod 302a and the client pod. Whenever a data packet is sent using the TLS connection, a MAC value is generated and appended for that data packet, and the receiver device may then be able to compute and verify the sent MAC value to ensure data packet integrity and authenticity.

Referring to FIG. 3D, the first client pod 302b may enter a client connected state (at 313) when the TLS connection 311 is established with the server pod 302a. While in the client connected state, the first client pod 302b may send and receive data packets (not shown) to and from the other client pods 302c, 302d via the server pod 302a.

At the next UDP beacon interval, the server pod 302a may transmit a subsequent UDP beacon 315 to identify the server pod 302a to any new client pods that joined the network since the previous interval, and to indicate to client pods 302b, 302c, 302d pods in network that the server pod 302a is functional.

While in the client connected state, the first client pod 302b may determine (at 317) if a UDP beacon is received from the server pod 302a during the subsequent UDP beacon interval.

The first client pod 302b may remain in the client connected state (at 319) when it is determined (at 317) that the UDP beacon is received from the server pod 302a during the subsequent UDP beacon interval during the client connected state.

Otherwise, the first client pod 302b may return to the client listen state (at 321) when it is determined (at 317) that the UDP beacon is not received from the server pod 302a during the subsequent UDP beacon interval while in the client connected state.

Referring to FIG. 3E, when the attempt to establish a TLS connection (at 309) with the server pod 302a during the client connect state fails, the first client pod 302b may return to the client listen state (at 323). While in the client listen state (at 301 and/or 321), the first client pod 302b may determine (at 325) if the at least one UDP beacon is received during a first time period of the client listen state.

When it is determined (at 325) the at least one UDP beacon is not received during the first time period of the client listen state, the first client pod 302b may enter a waiting period (at 327). The waiting period may be a predetermined or random time period (e.g., two times the beacon interval, five times the beacon interval, ten times the beacon interval, twenty times the beacon interval, etc.). Waiting a random time period may be useful to avoid multiple client pods simultaneously transmitting provisional UDP beacons. For example, the wireless pod that first transmits the provisional UDP beacon may be elected the server pod. Hence, if all wireless pods transmit a provisional UDP beacon concurrently, the server election procedure may fail.

In certain configurations, a provisional UDP beacon may be sent by a client pod during the server election process, and hence, the provisional UDP beacon may not need to include the information (e.g., port, IP address, etc.) that is included in a server UPD beacon. In other words, the purpose of the provisional UDP beacon may be to alert other client pods of the presence of the client pod broadcasting the provisional UDP beacon during the server election process, and not to enable a connection with other client pods.

At the end of the waiting period, the first client pod 302b may enter a listening period (at 329) to listen for a UDP beacon. During the listening period or at the conclusion of the listening period, the first client pod 302b may determine (at 331) if the at least one UDP beacon is received. In the particular example illustrated in FIG. 3E, the server pod 302a malfunctions (at 333), and hence, a UDP beacon (e.g., a server UDP beacon) is not transmitted by the server pod 302a. Thus, the first client pod 302b may determine (at 331) that a UDP beacon is not received.

Referring to FIG. 3F, the first client pod 302b may enter a server election state (at 335) when it is determined (at 331) that no UDP beacon is received from the server device during the listening period.

While in the server election state, the first client pod 302b may transmit a first provisional UDP beacon 337, and determine (at 339) if at least one second provisional beacon is received from one or more of the second client pod 302c and/or the third client pod 302d during a delay period of the server election state.

In the example illustrated in FIG. 3F, the third client pod 302d transmits a second provisional UDP beacon 341, and the first client pod 302b enters the waiting period (at 343) when it is determined (at 339) that at least one second provisional UDP beacon 341 is received from another client pod (e.g., the third client pod 302d).

In the example illustrated in FIG. 3G, the third client pod 302d may transmit a third provisional UDP beacon 345. The first client pod 302b may determine (at 347) if at least one third provisional UDP beacon is received from at least one of the other client pods during the entered listening period. The first client pod 302b may return to the client listen state (at 349) when it is determined that the at least one third provisional beacon is received from the one or more second devices during the listening period. Here, the third client pod 302d may become the newly elected server pod.

Otherwise, the first client pod 302b may enter the server election state (at 351) when it is determined that the at least one third UDP provisional beacon is not received from the one or more second devices during the entered listening period.

Referring to FIG. 3H, when it is determined (at 339) that the at least one second provisional UDP beacon is not received from at least one of the other client pods during the delay period of the server election state, the first client pod 302b may enter a server state (at 353) and become the newly elected server pod. While in the server state, the new server pod 302b may transmit a UDP beacon 355 to allow the second client pod 302c and the third client pod 302d to establish a TLS connection therewith.

In order to establish a TLS connection, the second client pod 302c may transmit a TLS connection request 357a and the third client pod 302d may transmit a TLS connection request 357b to the new server pod 302b upon receiving the UDP beacon 355 from the new server pod 302b. Once the UDP beacon 355 is transmitted, the new server pod 302b may determine (at 359) if a TLS connection request is received from one or more of the second client pod 302c or the third client pod 302d.

In the example illustrated in FIG. 3H, the new server pod 302b determines (at 359) that a TLS connection request is received from the second client pod 302c and the third client pod 302d, and hence, establishes a respective TLS connection 361a, 361b with the second client pod 302c and the third client pod 302d. For example, the TLS connections 361a, 361b may be established using the TLS protocol described above at 309.

When the TLS connections 361a, 361b are established, the second client pod 302c and the third client pod 302d may transmit respective registration messages 363a, 363b in order to register with the new server pod 302b. For example, the registration message 363a from the second client pod 302c and the registration message 363b from the third client pod 302d may include a respective identifier (e.g., a UUID).

Referring to FIG. 3I, the new server pod 302b may associate (at 365) the identifier received in the registration message 363a from the second client pod 302c with a first client identifier (e.g., a unique 16 bit number) and the identifier received in the registration message 363b from the third client pod 302d with a second client identifier (e.g., a unique 16 bit number). The new server pod 302b may transmit a first registration response 367a that includes the first client identifier to the second client pod 302c, and a second registration response 367b that includes the second client identifier to the third client pod 302d. The first registration response 367a and the second registration response 367b may also include a list of all of the unique client identifiers associated with all of the other registered pods in the network.

When one of the client pods in the network determines to send a message to another client pod (e.g., not the server pod) in the network, the transmitting client pod may include the unique client identifier of the intended recipient in the message that is sent to the new server pod 302b. The new server pod 302b may determine the intended recipient based on the unique client identifier included in the message, and relay the message to the intended recipient.

For example, the second client pod 302c may determine to send a data packet to the third client pod 302d. Using the list of unique client identifiers included in the registration response message 367a, the second client pod 302c may determine the unique client identifier associated with the third client pod 302d. The unique client identifier of the third client pod 302d may be included in the data packet 369, which is sent to the new server pod 302b. The new server pod 302b may determine the intended recipient based on the unique client identifier included (e.g., appended) to the message, and forward the data packet 371 to the third client pod 302d.

Using the techniques described above in connection with FIGS. 3C-3I, the present disclosure provides a mechanism by which the client pods 302b, 302c, 302d may be able to determine when the server pod 302a malfunctions and to elect a new server pod.

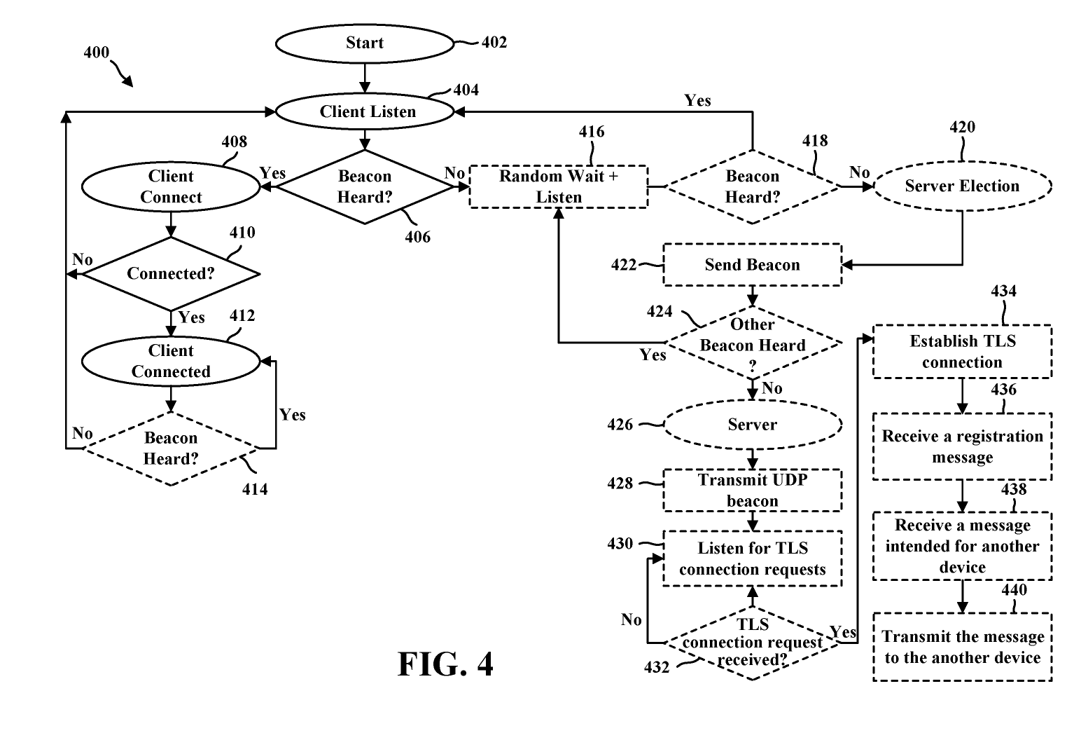

FIG. 4 is a flowchart 400 of a method of wireless communication. The method may be performed by a wireless pod (e.g., the first device 102, the third device 114, the server pod 302a, 560, the first client pod 302b, the second client pod 302c, the third client pod 302d, the apparatus 502/502′, the second wireless pod 550, the third wireless pod 555). In FIG. 4, optional operations are indicated with dashed lines. The operation begins at 402.

At 404, the wireless pod may enter a client listen state. For example, referring to FIG. 3C, the first client pod 302b may enter a client listen state (at 301). In certain aspects, the first client pod 302b may enter the client listen state when the first client pod 302b is initially powered-on, or when a UDP beacon is not received from server pod 302a when the first client pod 302b is in a client connected state (e.g., see operation 321 in FIG. 3D). For example, the first client pod 302b may enter the client listen state (at 301) for a duration that is at least as long as a transmission interval of the UDP beacon (e.g., 1 ms, 10 ms, 50 ms, 100 ms, etc.). In certain configurations, the first client pod 302b may enter the client listen state for a duration that is longer than the transmission interval of the UDP beacon (e.g., ten times longer than the transmission interval).

At 406, the wireless pod may determine if at least one UDP beacon is received from a server device during a client listen state. For example, referring to FIG. 3C, the first client pod 302b may determine (at 305) if a UDP beacon is received from the server pod 302a during the client listen state. If a UDP beacon is not received during the client listen state, the first client pod 302b may be the first wireless pod to join the network or the server pod 302a may not be functional.

When the wireless pod determines that the at least one UDP beacon is received from the server device during the client listen state (at 404), the wireless pod enters the client connect state (at 408). Otherwise, when the wireless pod determines that the at least one UDP beacon is not received from the server device during the client listen state (at 404), the wireless pod enters a random wait and listen period (at 416).

At 408, the wireless pod may enter a client connect state when it is determined that the at least one UDP beacon is received from the server device. For example, referring to FIG. 3C, the first client pod 302b receives the UDP beacon from the server pod 302a during the client listen state, and hence, enters a client connect state (at 307) when it is determined (at 305) that the at least one UDP beacon is received from the server pod 302a.

At 410, the wireless pod may attempt to establish a TLS connection with the server device during the client connect state. For example, referring to FIG. 3C, the first client pod 302b may attempt to establish a TLS connection (at 309) with the server pod 302a during the client connect state using a TLS protocol as described above. In certain aspects, the first client pod 302b may attempt to establish the TLS connection using the port indicated in the UDP beacon.

When the wireless pod establishes a TLS connection with the server device during the client connect state (at 410), the operation moves to 412. Otherwise, when the wireless pod is unable to establish a TLS connection with the server device during the client connect state (at 410), the operation returns to 404.

At 412, the wireless pod may enter a client connected state when the TLS connection is established with the server device. For example, referring to FIG. 3D, the first client pod 302b may enter a client connected state (at 313) when the TLS connection 311 is established with the server pod 302a. While in the client connected state, the first client pod 302b may send and receive data packets (not shown) to and from the other client pods 302c, 302d via the server pod 302a.

At 414, the wireless pod may determine if the at least one UDP beacon is received from the server device during the client connected state. For example, referring to FIG. 3D, while in the client connected state, the first client pod 302b may determine (at 317) if a UDP beacon is received from the server pod 302a during the subsequent UDP beacon interval.

When the wireless pod determines that the UDP beacon is received during the client connected state (at 414), the operation returns to 412. Otherwise, when the wireless pod determines that the UDP beacon is not received during the client connected state (at 412), the operation returns to 404.

At 416, the wireless pod may enter a waiting period when it is determined that the at least one UDP beacon is not received from the server device and may enter a listening period at the end of the waiting period. In one aspect, a duration of the at least one UDP beacon may be shorter than the listening period. For example, referring to FIG. 3E, the first client pod 302b may enter a waiting period (at 327). The waiting period may be a predetermined or random time period (e.g., two times the beacon interval, five times the beacon interval, ten times the beacon interval, twenty times the beacon interval, etc.). Waiting a random time period may be useful to avoid multiple client pods simultaneously transmitting provisional UDP beacons. At the end of the waiting period, the first client pod 302b may enter a listening period (at 329) to listen for a UDP beacon.

At 418, the wireless pod may determine if the at least one UDP beacon is received during the listening period. For example, referring to FIG. 3E, during the listening period or at the conclusion of the listening period, the first client pod 302b may determine (at 331) if the at least one UDP beacon is received. In the particular example illustrated in FIG. 3E, the server pod 302a malfunctions (at 333), and hence, a UDP beacon is not transmitted by the server pod 302a. Thus, the first client pod 302b may determine (at 331) that a UDP beacon is not received.

When it is determined that the at least one UDP beacon is received during the listening period (at 418), the operation returns to 404. Otherwise, when it is determined that the at least one UDP beacon is not received during the listening period (at 418), the operation moves to 420.

At 420, the wireless pod may enter a server election state when it is determined that the at least one UDP beacon is not received from the server device during the listening period. For example, referring to FIG. 3F, the first client pod 302b may enter a server election state (at 335) when it is determined (at 331) that the at least one UDP beacon is not received from the server device during the listening period.

At 422, the wireless pod may transmit at least one first provisional beacon during the server election state. For example, referring to FIG. 3F, while in the server election state, the first client pod 302b may transmit a first provisional UDP beacon 337.

At 424, the wireless pod may determine if at least one second provisional beacon is received from one or more second devices during a delay period of the server election state. In one aspect, the delay period of the server election state may occur after the at least one provisional beacon is transmitted. For example, referring to FIG. 3F, the first client pod 302b may determine (at 339) if at least one second provisional beacon is received from one or more of the second client pod 302c and/or the third client pod 302d during a delay period of the server election state.

When it is determined that at least one second provisional beacon is received from one or more second devices during a delay period of the server election state (at 424), the operation returns to 416. Otherwise, when it is determined that at least one second provisional beacon is not received from one or more second devices during a delay period of the server election state (at 424), the operation moves to 426.

At 426, the wireless pod may enter a server state when it is determined that the at least one second provisional beacon is not received from the one or more second devices during the delay period of the server election state. For example, referring to FIG. 3H, when it is determined (at 339) that the at least one second provisional UDP beacon is not received from at least one of the other client pods during the delay period of the server election state, the first client pod 302b may enter a server state (at 353) to become the newly elected server pod.

At 428, the wireless pod may transmit the at least one UDP beacon during the server state. For example, referring to FIG. 3H, while in the server state, the new server pod 302b may transmit a UDP beacon 355 to allow the second client pod 302c and the third client pod 302d to establish a TLS connection therewith.

At 430, the wireless pod may enter a listening period for TLS connection requests. For example, referring to FIG. 3H, after the UDP beacon 355 is transmitted, the new server pod 302b may listen for TLS connection requests.

At 432, the wireless pod may determine if a TLS connection request is received from the one or more second devices. For example, referring to FIG. 3H, once the UDP beacon 355 is transmitted, the new server pod 302b may determine (at 359) if a TLS connection request is received from one or more of the second client pod 302c or the third client pod 302d.

When it is determined that the TLS connection request is not received form the one or more second devices (at 432), the operation returns to 430. Otherwise, when it is determined that the TLS connection request is received form the one or more second devices (at 432), the operation moves to 434.

At 434, the wireless device may establish a TLS connection with the one or more second devices when it is determined that the TLS connection request is received. For example, referring to FIG. 3H, the new server pod 302b determines (at 359) that a TLS connection request is received from the second client pod 302c and the third client pod 302d, and hence, establishes a respective TLS connection 361a, 361b with the second client pod 302c and the third client pod 302d. For example, the TLS connections 361a, 361b may be established using the TLS protocol described above at 309.

At 436, the wireless pod may receive a registration message from each of the one or more second devices once the TLS connection is established. For example, referring to FIG. 3H, the second client pod 302c and the third client pod 302d may transmit respective registration messages 363a, 363b that are received by the new server pod 302b. In certain aspects, the registration message 363a from the second client pod 302c and the registration message 363b from the third client pod 302d may include a respective identifier (e.g., a UUID).

At 438, the wireless pod may receive a data packet from a first one of the one or more second devices. In one aspect, the data packet may be intended for a second one of the one or more second devices. For example, referring to FIG. 3I, The unique client identifier of the third client pod 302d may be included in the data packet 369, which is received by the new server pod 302b.

At 440, the wireless pod may transmit the data packet to the second one of the one or more second devices. For example, referring to FIG. 3I, the new server pod 302b may determine the intended recipient based on the unique client identifier included (e.g., appended) to the message, and forward the data packet 371 to the third client pod 302d.

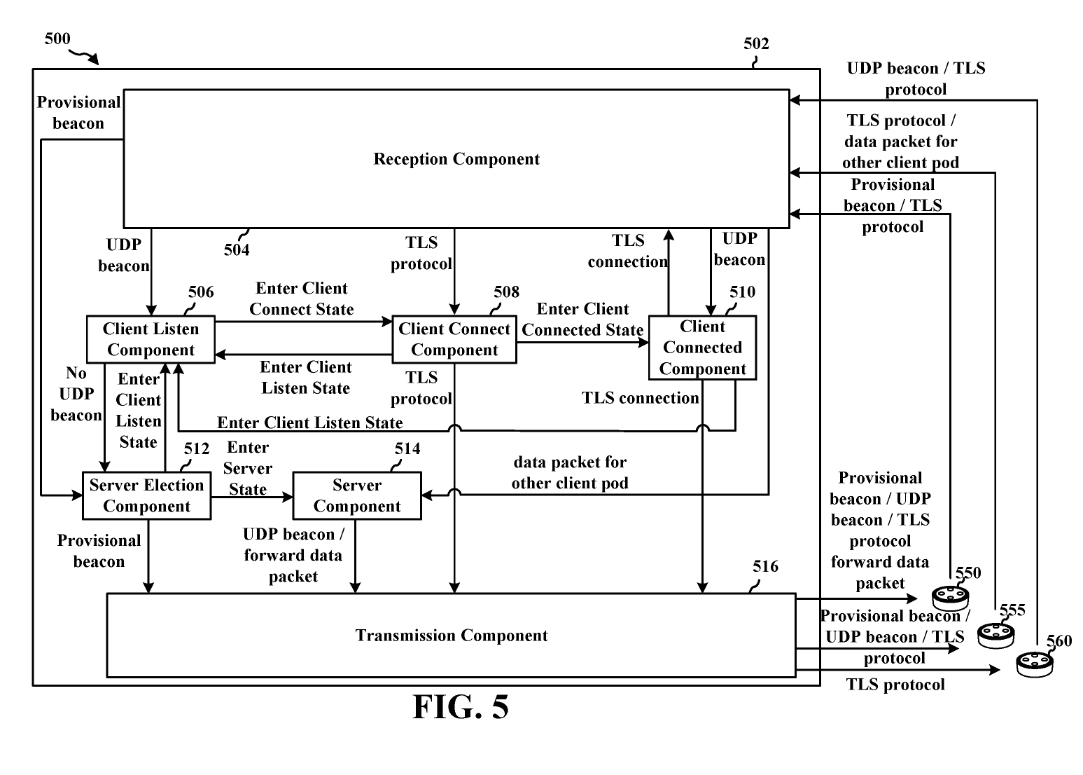

FIG. 5 is a conceptual data flow diagram 500 illustrating the data flow between different means/components in an exemplary apparatus 502. The apparatus may be a first wireless pod (e.g., the first device 102, the third device 114, the server pod 302a, 560, the first client pod 302b, the second client pod 302c, the third client pod 302d, the apparatus 502′,) in communication with a server pod 560 (e.g., the first device 102, the third device 114, the server pod 302a, 560, the first client pod 302b, the second client pod 302c, the third client pod 302d), a second wireless pod 550 (e.g., the first device 102, the third device 114, the server pod 302a, 560, the first client pod 302b, the second client pod 302c, the third client pod 302d), and a third wireless pod 555 (e.g., the first device 102, the third device 114, the server pod 302a, 560, the first client pod 302b, the second client pod 302c, the third client pod 302d). The apparatus may include a reception component 504, a client listen component 506, a client connect component 508, a client connected component 510, a server election component 512, a server component 514, and a transmission component 516.

In certain configurations, the client listen component 506 may be configured to enter a client listen state. The reception component 504 may be configured to receive at least one UDP beacon from the server pod 560 during one or more UDP beacon interval(s). The reception component 504 may be configured to send a signal indication the reception of the at least one UDP beacon received during each of the one or more UDP beacon intervals to the client listen component 506.

In certain other configurations, the client listen component 506 may be configured to determine if at least one UDP beacon is received from the server pod 560 during the client listen state. For example, the determination may be made based on whether or not a signal associated with a UDP beacon is received from the reception component 504.

In certain configurations, when the client listen component 506 determines that the at least one UDP beacon is received from the server pod 560 during the client listen state, the client listen component 506 may be configured to send a signal instructing the client connect component 508 to enter a client connect state. Otherwise, when the client listen component 506 determines that the at least one UDP beacon is not received from the server pod 560 during the client listen state, the client listen component may be configured to enter a random wait and listen period.

In certain configurations, the client connect component 508 may be configured to enter a client connect state when it is determined that the at least one UDP beacon is received from the server device. In certain other configurations, the client connect component 508 may be configured to attempt to establish a TLS connection with the server pod 560 during the client connect state. For example, the client connect component 508 may be configured to send one or more signals associated with a TLS protocol to the transmission component 516. The transmission component 516 may be configured to send one or more signals associated with the TLS protocol to the server pod 560. In certain configurations, the server pod 560 may be configured to send one or more signals associated with the TLS protocol to the reception component 504. The reception component 504 may be configured to send one or more signals associated with the TLS protocol to the client connect component 506. When the one or more signals associated with the TLS protocol is received, the client connect component 508 may be configured to send a subsequent TLS protocol signal to the transmission component. Based on the sequence of TLS protocol signals, the client connect component 508 may be configured to determine if a TLS connection may be established.

In certain configurations, when the client connect component 508 determines that a TLS connection can be established, the client connect component 508 may be configured to send a signal instructing the client connected component 510 to establish a TLS connection with the server pod 560 and enter a client connected state. Otherwise, when the client connect component 508 determines that a TLS connection cannot be established, the client connect component 508 may be configured to send a signal instructing the client listen component 506 to return to the client listen state.

In certain configurations, the client connected component 510 may be configured to send a signal associated with the established TLS connection to one or more of the reception component 504 and/or the transmission component 516. The reception component 504 and/or the transmission component 516 may be configured to maintain the TLS connection with the server pod 560. In certain other configurations, the client connected component 510 may be configured to enter a client connected state when the TLS connection is established with the server pod 560.

In certain other configurations, the client connected component 510 may be configured to determine if the at least one UDP beacon is received from the server device during the client connected state. In certain configurations, the reception component 504 may be configured to send a signal associated with at least one UDP beacon received from the server pod 560 during the client connected state to the client connected component 510. In certain other configurations, the client connected component 510 may be configured to determine if the at least one UDP beacon is received during the client connected state based on the signal associated with at least one UDP beacon received from the reception component 504.

In certain configurations, when the client connected component 510 determines that the at least one UDP beacon is received during the client connected state, the client connected component 510 may be configured to remain in the client connected state. Otherwise, when the client connected component 510 determines that the at least one UDP beacon is not received during the client connected state, the client connected component 510 may be configured to send a signal instructing the client listen component 506 to enter the client listen state.

In certain configurations, the client listen component 506 may be configured to enter a waiting period when it is determined that the at least one UDP beacon is not received from the server device and enter a listening period at the end of the waiting period. In one aspect, a duration of the at least one UDP beacon may be shorter than the listening period. The reception component 504 may be configured to send a signal associated with any UDP beacon(s) received during the listening period to the client listen component 506. In certain configurations, the client listen component 506 may be configured to determine if the at least one UDP beacon is received during the listening period. In certain configurations, the client listen component 506 may be configured to determine if the at least one UDP beacon is received during the listening period based on a signal received from the reception component 504.

In certain configurations, when the client listen component 506 determines that no UDP beacon is received during the listening period, the client listen component 506 may be configured to send a signal instructing the server election component 512 to enter a server election state. Otherwise, when the client listen component 506 determines that the at least one UDP beacon is received during the listening period (at 418), the client listen component 506 may enter the client connect state.

In certain configurations, the server election component 512 may be configured to enter a server election state when it is determined that the at least one UDP beacon is not received from the server pod 560 during the listening period. The server election component 512 may be configured to send a signal associated with a provisional UDP beacon during the server election state to the transmission component 516. The transmission component 516 may be configured to transmit and/or broadcast at least one first provisional beacon during the server election state. In certain configurations, the server election component 512 may be configured to determine if at least one second provisional beacon or server beacon is received from one or more second devices during a delay period of the server election state. In one aspect, the delay period of the server election state may occur after the at least one provisional beacon is transmitted. For example, if a provisional UDP beacon is received from the second wireless pod 550 and/or the third wireless pod 555, the reception component 504 may be configured to send a signal associated with the received provisional beacon to the server election component 512.

In certain configurations, when the server election component 512 determines that at least one second provisional beacon is received from the second wireless pod 550 and/or the third wireless pod 555 during a delay period of the server election state (at 424), the server election component 512 may send a signal instructing the client listen component 506 to enter the wait and listen period. Otherwise, when the server election component 512 determines that at least one second provisional beacon is not received from one or more second devices during a delay period of the server election state (at 424), the server election component 512 may send a signal instructing the server component 514 to enter the server state.

In certain configurations, the server component 514 may be configured to enter a server state when it is determined (e.g., by the server election component 512) that the at least one second provisional beacon is not received from the one or more second devices during the delay period of the server election state. In certain configurations, the server component 514 may be configured to send a signal associated with a UDP beacon to the transmission component 516. The transmission component 516 may be configured to transmit the at least one UDP beacon during the server state.

In certain configurations, the server component 514 may be configured to enter a listening period for TLS connection requests. For example, if a TLS connection request is received from the second wireless pod 550 and/or the third wireless pod 555, the reception component 504 may be configured to send a signal associated with the received TLS connection request(s) to the server component 514. In certain other configurations, the server component 514 may be configured to determine if a TLS connection request is received from the one or more second devices.

When the server component 514 determines that the TLS connection request is not received from the second wireless pod 550 and/or the third wireless pod 555, the server component 514 may be configured to enter the listening period for TLS connection requests. Otherwise, when the server component 514 determines that the TLS connection request is received from the second wireless pod 550 and/or the third wireless pod 555, the server component 514 may be configured to establish a TLS connection with the second wireless pod 550 and/or the third wireless pod 555.

In certain configurations, the server component 514 may be configured to receive a registration message from the second wireless pod 550 and/or the third wireless pod 555 once the TLS connection is established. For example, the reception component 504 may receive the registration message(s), and may be configured to send a signal associated with the registration message(s) to the server component 514.

In certain other configurations, the server component 514 may be configured to receive a data packet from a first one of the second wireless pod 550 and/or the third wireless pod 555. In one aspect, the data packet may be intended for a second one of the second wireless pod 550 and/or the third wireless pod 555. The reception component 504 may be configured to send a signal associated with the received data packet to the server component 514. The server component 514 may be configured to send a signal associated with the data packet and the intended wireless pod to the transmission component 516. The transmission component 516 may be configured to transmit the data packet to the second one of the second wireless pod 550 and/or the third wireless pod 555.

The apparatus may include additional components that perform each of the blocks of the algorithm in the aforementioned flowchart of FIG. 4. As such, each block in the aforementioned flowchart of FIG. 4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

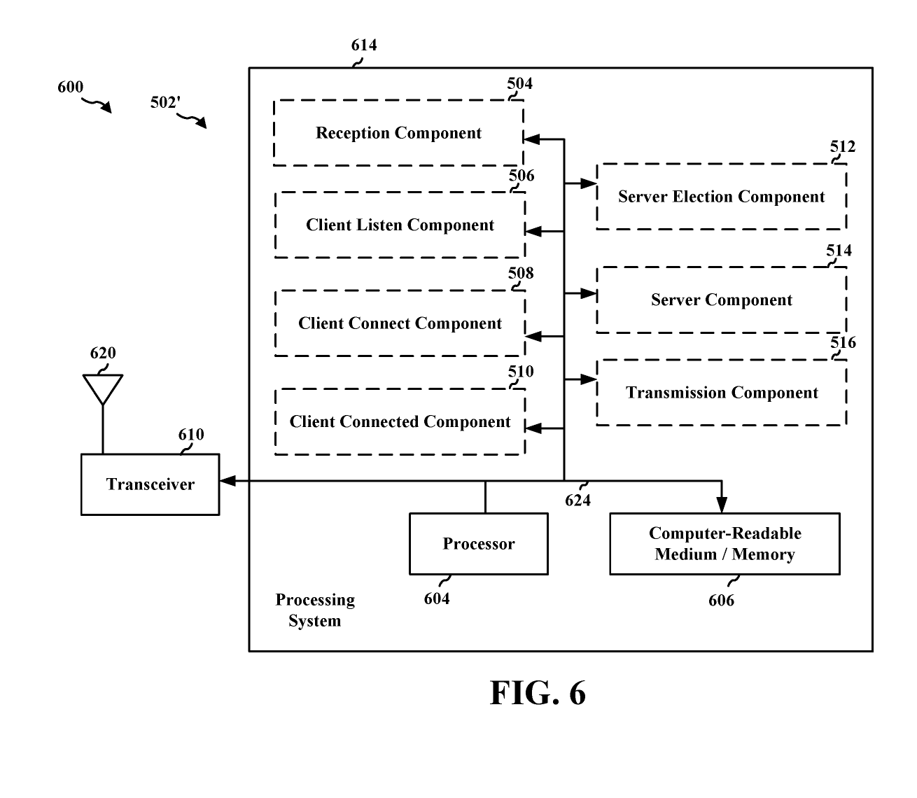

FIG. 6 is a diagram 600 illustrating an example of a hardware implementation for an apparatus 502′ employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware components, represented by the processor 604, the components 504, 506, 508, 510, 512, 514, 516 and the computer-readable medium/memory 606. The bus 624 may also link various other circuits such as timing sources, peripherals, voltage regulators, and power management circuits, which are well known in the art, and therefore, will not be described any further.

The processing system 614 may be coupled to a transceiver 610. The transceiver 610 is coupled to one or more antennas 620. The transceiver 610 provides a means for communicating with various other apparatus over a transmission medium. The transceiver 610 receives a signal from the one or more antennas 620, extracts information from the received signal, and provides the extracted information to the processing system 614, specifically the reception component 504. In addition, the transceiver 610 receives information from the processing system 614, specifically the transmission component 516, and based on the received information, generates a signal to be applied to the one or more antennas 620. The processing system 614 includes a processor 604 coupled to a computer-readable medium/memory 606. The processor 604 is responsible for general processing, including the execution of software stored on the computer-readable medium/memory 606. The software, when executed by the processor 604, causes the processing system 614 to perform the various functions described supra for any particular apparatus. The computer-readable medium/memory 606 may also be used for storing data that is manipulated by the processor 604 when executing software. The processing system 614 further includes at least one of the components 504, 506, 508, 510, 512, 514, 516. The components may be software components running in the processor 604, resident/stored in the computer readable medium/memory 606, one or more hardware components coupled to the processor 604, or some combination thereof.

In certain configurations, the apparatus 502/502′ for wireless communication may include means for entering a client listen state. In certain other configurations, the apparatus 502/502′ for wireless communication may include means for determining if at least one UDP beacon is received from a server device during a client listen state. In certain other configurations, the apparatus 502/502′ for wireless communication may include means for entering a client connect state when it is determined that the at least one UDP beacon is received from the server device. In certain other configurations, the apparatus 502/502′ for wireless communication may include means for attempting to establish a TLS connection with the server device during the client connect state. In certain other configurations, the apparatus 502/502′ for wireless communication may include means for entering a client connected state when the TLS connection is established with the server device. In certain other configurations, the apparatus 502/502′ for wireless communication may include means for determining if the at least one UDP beacon is received from the server device during the client connected state. In certain other configurations, the apparatus 502/502′ for wireless communication may include means for entering a waiting period when it is determined that the at least one UDP beacon is not received from the server device and may enter a listening period at the end of the waiting period. In one aspect, a duration of the at least one UDP beacon may be shorter than the listening period. In certain other configurations, the apparatus 502/502′ for wireless communication may include means for determining if the at least one UDP beacon is received during the listening period. In certain other configurations, the apparatus 502/502′ for wireless communication may include means for entering a server election state when it is determined that the at least one UDP beacon is not received from the server device during the listening period. In certain other configurations, the apparatus 502/502′ for wireless communication may include means for transmitting at least one first provisional beacon during the server election state. In certain other configurations, the apparatus 502/502′ for wireless communication may include means for determining if at least one second provisional beacon is received from one or more second devices during a delay period of the server election state. In one aspect, the delay period of the server election state may occur after the at least one provisional beacon is transmitted. In certain other configurations, the apparatus 502/502′ for wireless communication may include means for entering a server state when it is determined that the at least one second provisional beacon is not received from the one or more second devices during the delay period of the server election state. In certain other configurations, the apparatus 502/502′ for wireless communication may include means for transmit the at least one UDP beacon during the server state. In certain other configurations, the apparatus 502/502′ for wireless communication may include means for entering a listening period for TLS connection requests. In certain other configurations, the apparatus 502/502′ for wireless communication may include means for determining if a TLS connection request is received from the one or more second devices. In certain other configurations, the apparatus 502/502′ for wireless communication may include means for establishing a TLS connection with the one or more second devices when it is determined that the TLS connection request is received. In certain other configurations, the apparatus 502/502′ for wireless communication may include means for receiving a registration message from each of the one or more second devices once the TLS connection is established. In certain other configurations, the apparatus 502/502′ for wireless communication may include means for receiving a data packet from a first one of the one or more second devices. In one aspect, the data packet may be intended for a second one of the one or more second devices. In certain other configurations, the apparatus 502/502′ for wireless communication may include means for transmitting the data packet to the second one of the one or more second devices. The aforementioned means may be the processor(s) 202, the radio 230, the MMU 240, the WLAN controller 250, short-range communication controller 252, one or more of the aforementioned components of the apparatus 502 and/or the processing system 614 of the apparatus 502′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a first device, comprising:
determining if at least one user data protocol (UDP) beacon is received from a server device during a client listen state;
entering a client connect state when it is determined that the at least one UDP beacon is received from the server device during the client listen state; and
attempting to establish a transport layer security (TLS) connection with the server device during the client connect state.

2. The method of claim 1, further comprising:
entering a client connected state when the TLS connection is established with the server device; and
determining if the at least one UDP beacon is received from the server device during the client connected state.

3. The method of claim 2, further comprising:
remaining in the client connected state when it is determined that the at least one UDP beacon is received from the server device during the client connected state.

4. The method of claim 3, further comprising:
Entering the client listen state when it is determined that the at least one UDP beacon is not received from the server device during the client connected state.

5. The method of claim 2, further comprising:
entering the client listen state when the TLS connection is not established with the server device during the client connect state.

6. The method of claim 1, further comprising:
entering a waiting period when it is determined that the at least one UDP beacon is not received from the server device;
entering a listening period at an end of the waiting period; and
determining if the at least one UDP beacon is received during the listening period.

7. The method of claim 6, wherein a duration of the at least one UDP beacon is shorter than the listening period.

8. The method of claim 6, further comprising:
entering a server election state when it is determined that the at least one UDP beacon is not received from the server device during the listening period;
transmitting at least one first provisional beacon during the server election state; and
determining if at least one second provisional beacon is received from one or more second devices during a delay period of the server election state, the delay period of the server election state occurring after the at least one first provisional beacon is transmitted.

9. The method of claim 8, further comprising:
entering the waiting period when it is determined that the at least one second provisional beacon is received from the one or more second devices during the delay period of the server election state.

10. The method of claim 8, further comprising:
entering a server state when it is determined that the at least one second provisional beacon is not received from the one or more second devices during the delay period of the server election state.

11. The method of claim 10, further comprising:
transmitting the at least one UDP beacon during the server state;
determining if a TLS connection request is received from the one or more second devices;
establishing a TLS connection with the one or more second devices when it is determined that the TLS connection request is received;
receiving a registration message from each of the one or more second devices once the TLS connection is established; and
receiving a data packet from a first one of the one or more second devices, the data packet intended for a second one of the one or more second devices; and
transmitting the data packet to the second one of the one or more second devices.

12. The method of claim 11, wherein the registration message from each of the one or more second devices include a universally unique identifier (UUID) associated with a particular second device.

13. An apparatus for wireless communication for a first device, comprising:
a memory; and
at least one processor coupled to the memory and configured to:
determine if at least one user data protocol (UDP) beacon is received from a server device during a client listen state;
enter a client connect state when it is determined that the at least one UDP beacon is received from the server device during the client listen state; and
attempt to establish a transport layer security (TLS) connection with the server device during the client connect state.

14. The apparatus of claim 13, wherein the at least one processor is further configured to:
enter a client connected state when the TLS connection is established with the server device; and
determine if the at least one UDP beacon is received from the server device during the client connected state.

15. The apparatus of claim 14, wherein the at least one processor is further configured to:
remain in the client connected state when it is determined that the at least one UDP beacon is received from the server device during the client connected state.

16. The apparatus of claim 15, wherein the at least one processor is further configured to:
enter the client listen state when it is determined that the at least one UDP beacon is not received from the server device during the client connected state.

17. The apparatus of claim 14, wherein the at least one processor is further configured to:
enter the client listen state when the TLS connection is not established with the server device during the client connect state.

18. The apparatus of claim 13, wherein the at least one processor is further configured to:
enter a waiting period when it is determined that the at least one UDP beacon is not received from the server device;
entering a listening period at an end of the waiting period; and
determine if the at least one UDP beacon is received during the listening period.

19. The apparatus of claim 18, wherein a duration of the at least one UDP beacon is shorter than the listening period.

20. The apparatus of claim 18, wherein the at least one processor is further configured to:
enter a server election state when it is determined that the at least one UDP beacon is not received from the server device during the listening period;
transmit at least one first provisional beacon during the server election state; and
determine if at least one second provisional beacon is received from one or more second devices during a delay period of the server election state, the delay period of the server election state occurring after the at least one first provisional beacon is transmitted.

21. The apparatus of claim 20, wherein the at least one processor is further configured to:
enter the waiting period when it is determined that the at least one second provisional beacon is received from the one or more second devices during the delay period of the server election state.

22. The apparatus of claim 20, wherein the at least one processor is further configured to:
enter a server state when it is determined that the at least one second provisional beacon is not received from the one or more second devices during the delay period of the server election state.

23. The apparatus of claim 22, wherein the at least one processor is further configured to:
transmit the at least one UDP beacon during the server state;
determine if a TLS connection request is received from the one or more second devices;
establish a TLS connection with the one or more second devices when it is determined that the TLS connection request is received;
receive a registration message from each of the one or more second devices once the TLS connection is established; and
receive a data packet from a first one of the one or more second devices, the data packet intended for a second one of the one or more second devices; and
transmitting the data packet to the second one of the one or more second devices.

24. The apparatus of claim 23, wherein the registration message from each of the one or more second devices include a universally unique identifier (UUID) associated with a particular second device.

25. An apparatus for wireless communication for a first device, comprising:
means for determining if at least one user data protocol (UDP) beacon is received from a server device during a client listen state;
means for entering a client connect state when it is determined that the at least one UDP beacon is received from the server device during the client listen state; and
means for attempting to establish a transport layer security (TLS) connection with the server device during the client connect state.

26. The apparatus of claim 25, further comprising:
means for entering a waiting period when it is determined that the at least one UDP beacon is not received from the server device;
entering a listening period at an end of the waiting period; and
means for determining if the at least one UDP beacon is received during the listening period.

27. The apparatus of claim 26, wherein a duration of the at least one UDP beacon is shorter than the listening period.

28. The apparatus of claim 26, further comprising:
means for entering a server election state when it is determined that the at least one UDP beacon is not received from the server device during the listening period;
means for transmitting at least one first provisional beacon during the server election state; and
means for determining if at least one second provisional beacon is received from one or more second devices during a delay period of the server election state, the delay period of the server election state occurring after the at least one first provisional beacon is transmitted.

29. The apparatus of claim 28, further comprising:
means for entering the waiting period when it is determined that the at least one second provisional beacon is received from the one or more second devices during the delay period of the server election state; and
means for entering a server state when it is determined that the at least one second provisional beacon is not received from the one or more second devices during the delay period of the server election state.

30. A computer-readable medium storing computer executable code for a first device, comprising code to:
determine if at least one user data protocol (UDP) beacon is received from a server device during a client listen state;
enter a client connect state when it is determined that the at least one UDP beacon is received from the server device during the client listen state; and
attempt to establish a transport layer security (TLS) connection with the server device during the client connect state.
